(19) United States
(12) Patent Application Publication
(10) Pub. No.: US 2004/0167937 A1
(43) Pub. Date: Aug. 26, 2004

(54) Version-insensitive serialization and deserialization of program objects

(75) Inventors: Eric A. Sirois, Toronto (CA); Kit Man Cheung, Toronto (CA); Peter W. Kohlmann, Markham (CA); Gordon D. Lipford, Guelph (CA); Mark Mezofenyi, Toronto (CA); Belal A. Tassi, Toronto (CA); Theresa Xu, Scarborough (CA)

Correspondence Address: Cynthia S. Byrd, International Business Machines, 11400 Burnet Rd., Austin, TX, 78758, US

(73) Assignee: INTERNATIONAL BUSINESS MACHINES CORPORATION, ARMONK, NY

(21) Appl. No.: 10/426,521

(22) Filed: Apr. 29, 2003

(30) Foreign Application Priority Data
Feb. 26, 2003 (CA) 2,419,904

(51) Int. Cl. G06F 17/30

(52) U.S. Cl. 707/203

(57) ABSTRACT

A method for serializing and deserializing program objects that is versioning sensitive. A program object is serialized into a persistent object by saving only those data fields that contain non-default data. The persistent object is deserialized to be used by a deserializing application by first creating a blank program object of the same version as the deserializing application and then populating it with the non-default data stored in the persistent object. The version of the deserializing application need not be the same as the version of the serializing application.

### FIELD OF THE INVENTION

This invention relates to the storage and retrieval of program objects used by computer software products; and more specifically, the present invention relates to version-insensitive serialization and deserialization of program objects.

### BACKGROUND OF THE INVENTION

A common method of storing data contained in a program object for later use by a computer software application is to serialize the data. Serialization involves reading the data contained in the program object and writing it out to a persistent object, which is often a flat file, stored on a storage media.

The creation of a persistent object allows subsequent sessions of an application to retrieve the persistent object, deserialize it, and thereby reconstitute the program object.

A problem that often arises is that the deserializing application may be a different version of the application than the serializing application. As applications change and evolve over different versions, the structure and layout of particular classes of program objects may be modified. In some cases, additional data fields, structures or objects may be added to or dropped from class definitions as an application evolves. Accordingly, one version of an application may create a program object (i.e. an instance of a particular class) that contains different data fields than a similar object from the same class created by a different version of the application.

This problem manifests itself in particular in networked applications wherein multiple versions of a server application and client applications may be in use across the network and the various versions of the applications may be attempting to access persistent objects created by each other.

One solution has been to write the version number of the application into the persistent object. This solution envisages that the deserializing application will read the version number in the persistent object and will create a reconstituted program object having a structure and semantics particular to that version. This solution requires that the deserializing application maintains multiple code streams to deal with the various past versions, and requires that the application adapt to the version of the serialized program object, i.e. the application is version adaptive. The ability to accommodate serialized program objects from earlier versions is often termed backward compatibility. Conversely, the ability to accommodate serialized program objects from later versions is termed forward compatibility. The version adaptive solution has difficulty accommodating forward compatibility.

### SUMMARY OF THE INVENTION

The present invention provides a version-insensitive system and method to address the versioning difficulties outlined above.

In one aspect, the present invention provides a method for reconstituting a program object from a persistent object using a computer system, the persistent object being stored on a storage media, the persistent object including a program object identification and field information, the field information including at least one field name and corresponding field data for each field name. The method includes the steps of parsing the persistent object to obtain the program object identification and to obtain the field names and their corresponding field data, creating a blank program object based upon the program object identification, the blank program object having a set of fields, each blank object field having a blank object field name and a blank object field data location, wherein the blank object field data locations are initialized with default values, and for each obtained field name from the persistent object, searching the blank program object for a matching blank object field name, and if the matching blank object field name is found, copying the corresponding field data for the obtained field name into the blank object field location corresponding to the matching blank object field name.

In another aspect, the present invention provides a method of serializing an initial program object using a computer system, the initial program object including initial field names and corresponding initial field data, the initial program object further including an object identifier. The method includes the steps of creating a persistent object, writing a program object identification to the persistent object based upon the object identifier, and, for each initial field name, determining whether the corresponding initial field data includes non-default data, and, if the corresponding initial field data is non-default data, writing the initial field name and the corresponding initial field data to the persistent object.

In another aspect, the present invention provides a computer program product having a computer readable medium tangibly embodying computer executable instructions for directing a data processing system to reconstitute a program object from a persistent object using a computer system, the persistent object being stored on a storage media, the persistent object including a program object identification and field information, the field information including at least one field name and corresponding field data for each field name. The computer executable instructions include computer executable instructions for directing the data processing system to parse the persistent object to obtain the program object identification and to obtain the field names and their corresponding field data, computer executable instructions for directing the data processing system to create a blank program object based upon the program object identification, the blank program object having a set of fields, each blank object field having a blank object field name and a blank object field data location, wherein the blank object field data locations are initialized with default values, and computer executable instructions for directing the data processing system to search the blank program object for a matching blank object field name for each obtained field name form the persistent object, and if the matching blank object field name is found, copy the corresponding field data for the obtained field name into the blank object field location corresponding to the matching blank object field name.

In another aspect, the present invention provides a computer program product having a computer readable medium tangibly embodying computer executable instructions for directing a data processing system to serialize an initial program object using a computer system, the initial program object including initial field names and corresponding initial field data, the initial program object further including an object identifier. The computer executable instructions include computer executable instructions for directing the data processing system to create a persistent object, computer executable instructions for directing the data processing system to write a program object identification to the persistent object based upon the object identifier, and computer executable instructions for directing the data processing system to determine whether the corresponding initial field data includes non-default data for each initial field name, and, if the corresponding initial field data is non-default data, write the initial field name and the corresponding initial field data to the persistent object.

In yet another aspect, the present invention provides a data processing system for reconstituting a program object from a persistent object using a computer system, the persistent object being stored on a storage media, the persistent object including a program object identification and field information, the field information including at least one field name and corresponding field data for each field name. The data processing system includes means for parsing the persistent object to obtain the program object identification and to obtain the field names and their corresponding field data, means for creating a blank program object based upon the program object identification, the blank program object having a set of fields, each blank object field having a blank object field name and a blank object field data location, wherein the blank object field data locations are initialized with default values, and means for searching the blank program object for a matching blank object field name for each obtained field name from the persistent object, and if the matching blank object field name is found, copying the corresponding field data for the obtained field name into the blank object field location corresponding to the matching blank object field name.

In yet another aspect, the present invention provides a data processing system for serializing an initial program object using a computer system, the initial program object including initial field names and corresponding initial field data, the initial program object further including an object identifier. The data processing system includes means for creating a persistent object, means for writing a program object identification to the persistent object based upon the object identifier, and means for determining whether the corresponding initial field data includes non-default data for each initial field name, and, if the corresponding initial field data is non-default data, writing the initial field name and the corresponding initial field data to the persistent object.

In a further aspect, the present invention provides an article including a computer readable signal bearing medium, and including means in the medium for directing a data processing system to reconstitute a program object from a persistent object using a computer system, the persistent object being stored on a storage media, the persistent object including a program object identification and field information, the field information including at least one field name and corresponding field data for each field name, the article including: means in the medium for parsing the persistent object to obtain the program object identification and to obtain the field names and their corresponding field data, means in the medium for creating a blank program object based upon the program object identification, the blank program object having a set of fields, each blank object field having a blank object field name and a blank object field data location, wherein the blank object field data locations are initialized with default values, and means in the medium for searching the blank program object for a matching blank object field name for each obtained field name from the persistent object, and if the matching blank object field name is found, copying the corresponding field data for the obtained field name into the blank object field location corresponding to the matching blank object field name.

In a further aspect, the present invention provides an article including a computer readable signal bearing medium, and including means in the medium for directing a data processing system to serialize an initial program object using a computer system, the initial program object including initial field names and corresponding initial field data, the initial program object further including an object identifier, the article including: means in the medium for creating a persistent object, means in the medium for writing a program object identification to the persistent object based upon the object identifier, and means in the medium for determining whether the corresponding initial field data includes non default data for each initial field name, and, if the corresponding initial field data is non default data, writing the initial field name and the corresponding initial field data to the persistent object.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows a computer system upon which the present invention may be implemented;

FIG. 2 shows an embodiment of a serialization method for serializing a program object, according to the present invention;

FIG. 3 shows an embodiment of a deserialization method for reconstituting a program object, according to the present invention;

FIG. 4 shows, in diagrammatic form, a serializer module and a deserializer module, according to the present invention, in a first example;

FIG. 5 shows, in diagrammatic form, the serializer module and the deserializer module, according to the present invention, in a second example;

FIG. 6 shows, in diagrammatic form, the serializer module and the deserializer module, according to the present invention, in a third example; and

FIG. 7 shows, in diagrammatic form, the serializer module and the deserializer module, according to the present invention, in a fourth example.

Similar references are used in different figures to denote similar components or features.

### DESCRIPTION OF SPECIFIC EMBODIMENTS

The following detailed description of specific embodiments of the present invention does not limit the implementation of the invention to any particular computer programming language. The present invention may be implemented in any computer programming language provided that the operating system provides the facilities to support the requirements of the present invention. In one embodiment, the present invention is implemented, at least partly, in the Java computer programming language. Any limitations presented herein as a result of a particular type of operating system or computer programming language are not intended as limitations of the present invention.

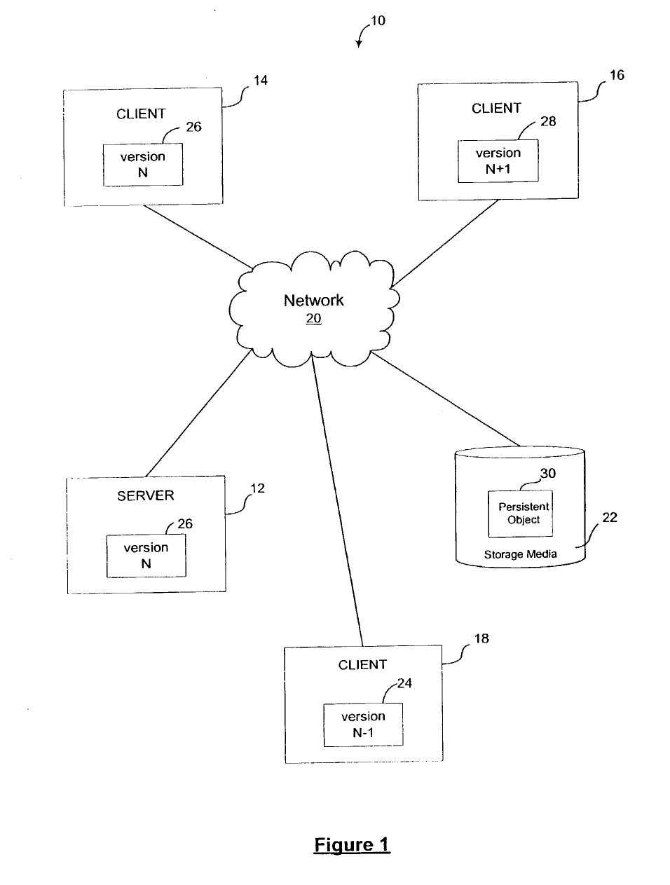

Reference is first made to FIG. 1, which shows a computer system 10 upon which the present invention may be implemented. The computer system 10 includes a server 12 and three clients 14, 16, and 18 which are interconnected by a network 20. In one embodiment, the network 20 may be the Internet. The system 10 further includes a storage media 22 connected to the network 20. The storage media 22 may be accessed by the server 12 and the clients 14, 16, and 18. Any of the server 12, the clients 14, 16 and 18, and the storage media 22 may be located remotely from one another or may share a location. The configuration of the computer system 10 is not intended as a limitation of the present invention, as will be understood by those of ordinary skill in the art from a review of the following detailed description.

The server 12 and the clients 14, 16, and 18, each include an application. There are three versions of the application operating within the system 10: a version N 26, a version N1 24, and a version N+1 28. The version N1 24 is a version of the application that predates the version N 26, and the version N+1 28 is a version of the application that postdates the version N 26.

The storage media 22 contains a persistent object 30 that has been created by one of the versions 24, 26, or 28 of the application during an active session and stored in memory on the storage media 22. During a session, the application may have data stored in a programming object which the application would like to have available for use in subsequent sessions, i.e. it is desired that the programming object persist across sessions. Accordingly, the application serializes the data in the programming object, writing it to the persistent object 30, which is stored on the storage media 22. In a subsequent session, the persistent object 30 may be deserialized by the application to reconstitute the programming object from which the data was originally obtained.

If the persistent object 30 was serialized by the version N 26 of the application, then it may be deserialized by the version N 26 of the application 26 without difficulty. However, in some cases a different version of the application, such as the version N1 24 or the version N+1 28, may attempt to deserialize a persistent object 30 created by the version N 26 of the application. In this situation, the persistent object 30 may be missing certain data elements that the deserializing application is expecting to find, or it may contain certain data elements that the deserializing application does not recognize and cannot handle. These problems can arise when different versions of the application use different structures or semantics for the programming object.

The present invention provides a system and method of serializing and deserializing programming objects so as to minimize the versioning problems that arise without the requirement to maintain multiple code streams in each version of the application to handle program objects originating from a different version of the application.

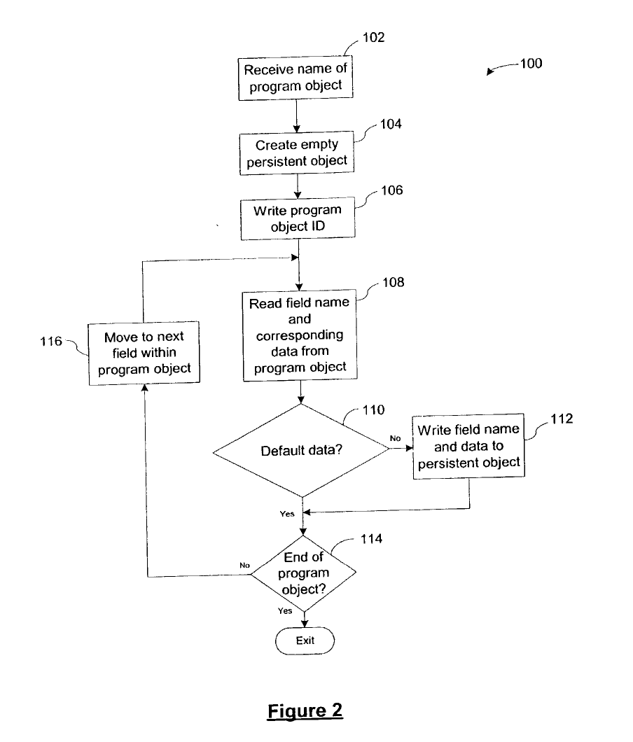

Reference is now made to FIG. 2, which shows a serialization method 100 of creating the persistent object 30 (FIG. 1) according to the present invention. The serialization method 100 may be performed by an active application with which there is associated a program object. The program object contains data that the active application wishes to preserve by creating and storing the persistent object. In one embodiment, the serialization method 100 is implemented by a serializer module.

The serialization method 100 begins in step 102 when the serializer module receives the program object.

At step 104, the serializer module creates an empty persistent object to which the data in the program object can be serialized. In one embodiment, this includes opening a file or allocating memory. In one embodiment, the persistent object is an XML (extensible Markup Language) file.

The serializer module then writes program object identification data to the empty persistent object in step 106. The program object identification data includes identifying data from which the application could later determine the type of program object that was serialized. For example, the program object identification data may include the name of the program object. In one embodiment, the name of the program object includes a class name, the class name referring to a class that defines the structure of the program object. The program object identification data may include a class name or packaging information. In one embodiment, the serializer module refers to a lookup table to obtain an identification code corresponding to the class and packaging information for the program object and it stores the identification code in the persistent object.

In step 108, the serializer module begins reading through the program object to locate initialized data fields. For each data field, the serializer module reads the field name and the data stored in the field. In step 110, for each data field the serializer module evaluates whether the data stored in the field is default data. Each type of data field has a default setting. For example, the default entry for an integer field may be zero; the default entry for a Boolean field may be FALSE; and the default entry for a float field may be 0.0. The default settings for particular fields are determined by the programming language used in the embodiment of the invention. For instance, with the Java programming language there are established default values for certain data types, such as the default values given for the above examples. Other programming languages may have other default values.

If the data stored in the field is not default data, then the serializer module continues to step 112, where the serializer module writes the field name and the data stored in the field to the persistent object. If the data is default data, then the serializer module continues without writing the data to the persistent object. In either case, at step 114 the serializer module determines whether it has reached the end of the program object, i.e. whether there are no further data fields to read. If there is further data, then at step 116 the serializer module moves to the next data field in the program object and loops back to step 110 to read the next data field.

Once the serializer module has reached the end of the data fields in the program object, it exits the serialization method 100 from step 114. Just before exiting, the serializer module may perform any clean up steps necessary to finish storing the persistent object 30 upon the storage media 22 (FIG. 1), such as closing the file, or other tasks.

Accordingly, the serializer module creates and stores the persistent object 30 by reading through the program object and writing out field names and data only for initialized data fields containing non-default data.

The serialization method 100 permits the serialization of _nested_data, such as object references. With an object reference in particular, the serializer module saves the object identification, just as in step 106 with respect to the program object, and then saves the data fields of the referenced object in the same manner as for the program object. The data types that may be serialized include integers, Booleans, floats, object references, arrays, character strings, and many other data types, as will be understood by those of ordinary skill in the art.

Those of ordinary skill in the art will also recognize that the serialization method 100 may be implemented by first reading in all the data fields at step 108 and then evaluating each field in step 110, or by reading one data field at a time in step 108 and evaluating it in step 110 before looping back to step 108 to read the next data field. Other implementations may also be possible without departing from the principal characteristics of the serialization method 100.

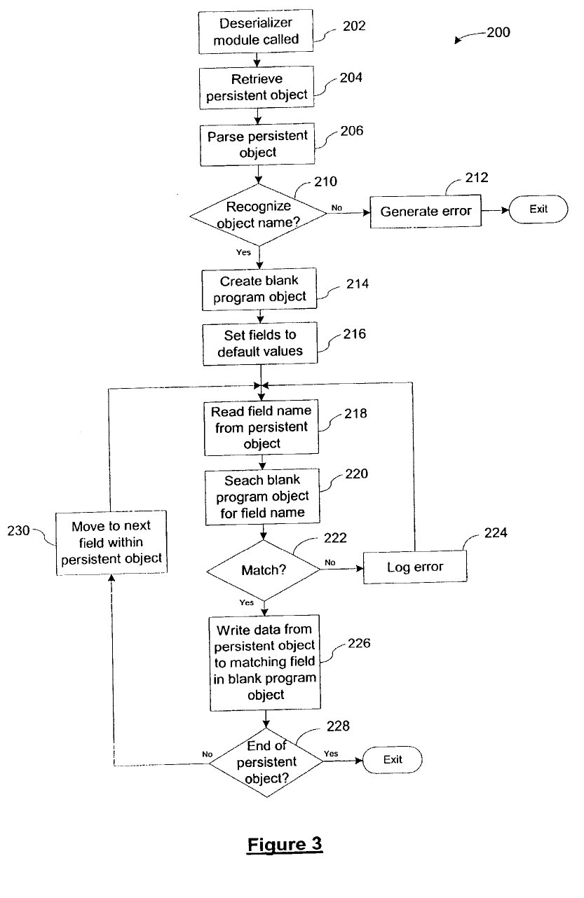

Reference is now made to FIG. 3, which shows a deserialization method 200 for reconstituting a program object from the persistent object 30 (FIG. 1). The deserialization method 200 may be performed by an active application which, in one embodiment, includes a deserializer module. The deserializer module carries out the steps of the deserialization method 200 to create a reconstituted program object from the persistent object 30 (Fig.1).

The deserialization method 200 begins in step 202 when the deserializer module is called. The deserializer module receives information sufficient to identify and retrieve the persistent object 30 from the storage media 22. Based upon this information, the deserializer module retrieves the persistent object 30 in step 204.Once it has the persistent object 30, the deserializer module parses the persistent object 30 in step 206. The persistent object 30 is parsed so as to extract the program object identification data and the data field information. This step may be performed in a single pass through the persistent object 30, thereby creating a parsed persistent object, or it may be done stepwise as the deserialization method 200 progresses. For instance, the persistent object 30 may only be parsed in step 206 as far as necessary to extract the program object identification data in order to perform the next step.

Once the deserializer module has extracted the program object identification data from the persistent object 30, in step 210 it attempts to recognize the program object. The deserializer module is associated with a version of an application that includes a variety of classes. The deserializer module attempts to match the program object identification data from the persistent object 30, which may include a class name, with the classes that the deserializing application can recognize. In one embodiment, the program object identification data includes an identification code and the deserializer module refers to a lookup table that relates the identification code to a particular class of program object.

If the deserializer module is unable to locate a known class corresponding to the program object identification data, then, in step 212, the deserializer module generates an error. The error may include a message to the deserializing application indicating that the persistent object 30 is incompatible with the particular version of the application.

If the deserializer module is able to locate a known class corresponding to the program object identification data, then, in steps 214 and 216, the deserializer module creates a blank program object according to that class and ensures that all the data fields in the blank program object are set to their default values. In other words, every data field in the blank program object is initialized to a default setting. Because the persistent object 30 does not contain any data from the original program object if the data field had contained a default value, the deserializer module first assumes that all the data fields are set to their default values until it discovers that the persistent object 30 indicates otherwise.

The blank program object created by the deserializer module in step 214 is a program object defined by a class that may be of a different version than the class that defined the original program object used to create the persistent object 30. It may be of an earlier version or a later version. The deserializer module proceeds on the assumption that it is creating a program object of the same version as the deserializing application. It does not perform any versionspecific transformations to accommodate changes in the class definition across versions. Accordingly, the version of the reconstituted program object will always be the same as the version of the deserializing application.

After creation of the blank program object with data fields initialized to default settings, in step 218 the deserializer begins reading data information from the persistent object 30. In step 218, it reads the first field name found in the persistent object 30. Then in step 220, the deserializer module attempts to find a matching field name in the blank program object. If the serializing application and the deserializing application are of the same version, then the deserializer module will always be able to match the field name, since the program object will be identically defined by both applications. If, however, the versions are different, the deserializing application may have a class definition that is missing some of the data fields or that contains additional data fields. Accordingly, the persistent object 30 may contain a field name not present in the blank program object.

In step 222, the deserializer module evaluates whether a match is found, and, if not, then it proceeds to step 224 where it generates an error. The error is logged in an error file or structure, the deserializer module advances to the next field name, and the deserialization method 200 continues at step 218.

In one embodiment, the error generation in step 224 may include sending a message to the application that the persistent object 30 is of an incompatible version and cannot be deserialized. The error message may indicate that the persistent object 30 contains certain data which would be lost if deserialized, and the deserializing application may have the power to override this error, causing the deserialization method 200 to continue despite the loss of this data.

If the deserializer module does locate a matching field name in the blank program object, then from step 222 it proceeds to step 226, where it retrieves the field data in the persistent object 30 corresponding to the field name. It writes this field data into the data field location in the blank program object corresponding to the matched field name. In this manner, the deserializer module populates the fields of the blank programming object with the data stored in the persistent object 30 based upon matching the field names.

Following step 226, the deserializer module determines whether it has reached the end of the persistent object 30, i.e. whether there are no further data fields stored in the persistent object 30. If so, then the deserializer module has completed its deserialization of the persistent object 30 and has created a reconstituted program object for use by the application. If not, then the deserializer module steps through the persistent object 30 to the next field name in step 230 and loops back to step 218 to repeat the process of reading the field name and attempting to locate a match in the blank program object.

If the deserializer module has completed its task, then upon exiting it may notify the deserializing application of any errors encountered and logged in the error file or structure in step 224. The deserializing application may determine whether or not the reconstituted program object is recoverable in spite of the errors. In one embodiment, the deserializing application may seek the user_s input regarding whether or not to continue in spite of the errors encountered. Proceeding in spite of the errors implies that any data that was not deserialized due to the absence of any matching field names will be discarded and lost.

It will be appreciated by those of ordinary skill in the art that some of the steps of the deserialization method 200 described above may be varied or reorganized, while achieving the same function; namely, the creation of a blank program object having fields which are initialized to default settings and then populated with data from the persistent object, thereby creating a reconstituted program object of the same version as the deserializing application.

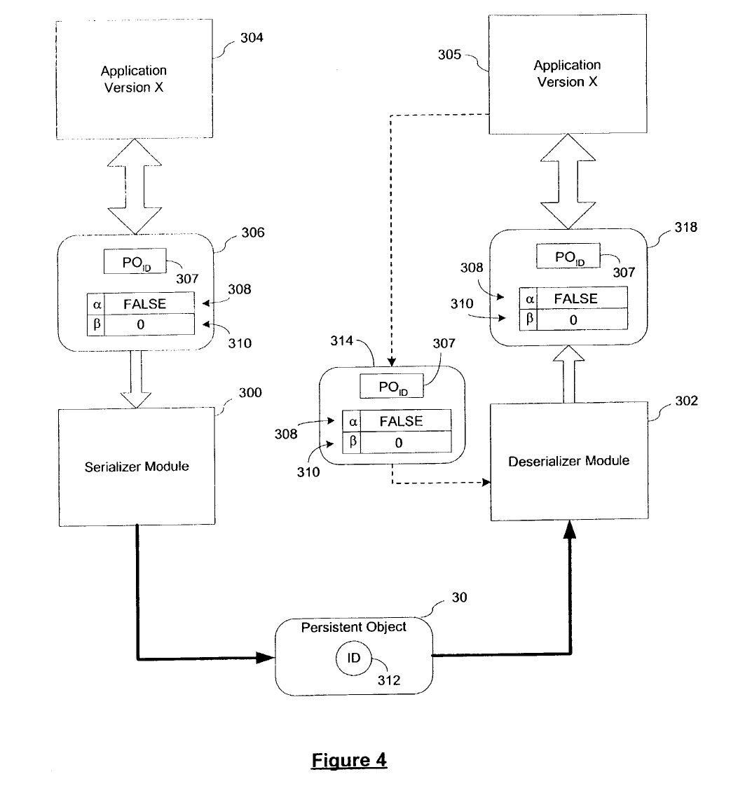

Reference is now made to FIG. 4, which shows, in diagrammatic form, a serializer module 300 and a deserializer module 302, according to the present invention, in a first example. The serializer module 300 is associated with a serializing application 304. The deserializer module 302 is associated with a deserializing application 305. Both the serializing and deserializing application 304, 305 are version X of the application.

During a first session, the serializing application 304 develops an initial program object 306. The serializing application 304 includes a class definition for the initial program object 306 that defines it as containing two fields of data, a first field 308 and a second field 310. The first field 308 may, for example, be a Boolean field named _. The second field 310 may, for example, be an integer field named _. The initial program object 306 also includes a program object identification 307 by which the class of the object may be identified. For instance, the name of the class may be _Backup_, and the initial program object 306 may be a particular instance of the _Backup_ class, and its program object identification 307 may be _Backup_.

In the example depicted in FIG. 4, the first field 308 in the initial program object 306 is set to FALSE, and the second field 310 is set to 0, i.e. both fields 308, 310 contain default data. Accordingly, the first and second fields 308, 310 are not to be serialized by the serializer module 300. In another example, the initial program object 306 may contain data fields such as vectors, arrays or structures which may not be initialized and, thus, contain no data. Uninitialized data fields will also not be serialized.

In accordance with the serialization method 100 (FIG. 2), the serializer module 300 reads the initial program object 306. In particular, it reads the program object identification 307 and writes a program object ID 312 to the persistent object 30. The program object ID 312 may be identical to the program object identification 307. In one embodiment, the program object ID 312 is a shorthand numeric code derived from the program object identification 307 based upon a lookup table. In this example, the serializer module 300 does not write any further data to the persistent object 30 because the first and second fields 308, 310 of the initial program object 306 do not contain any non-default data.

At some time later, the deserializer module 302 retrieves the persistent object 30 created by the serializer module 300 and parses the persistent object 30 in accordance with the deserialization method 200 (FIG. 3) to obtain the program object ID 312. Based upon the program object ID 312, the deserializer module 302 determines whether it recognizes this type of object. If so, then the deserializer module 302 constructs a blank program object 314 and initializes its data fields to the default settings. The deserializer module 302 may include a list of classes of program objects defined and recognized by the deserializing application 305 with which it is associated, in which case it can consult the list to determine if it recognizes the program object ID 312. If the program object ID 312 is not the same as the class name, then the deserializer module 302 may consult a lookup table to translate the program object ID 312 to a class name, or the list of recognized classes may include the program object IDs 312.

In this example, because the deserializing application 305 is of the same version X as the serializing application 304, it contains all the same class definitions and the program object ID 312 is recognized by the deserializer module 302. Accordingly, the deserializer module 302 creates the blank program object 314 based upon the version X class definition corresponding to the program object ID 312. The blank program object 314 has the same first and second data fields 308, 310 as the initial program object 306.

The deserializer module 302 then scans through the persistent object 30 to look for serialized field names. In this example, there are none. The persistent object 30 only contains the program object ID 312, so the deserializer module 302 does not populate the data fields of the blank program object 314 with any data. The blank program object 314 becomes a reconstituted program object 318 for use by the deserializing application 305. The reconstituted program object 318 contains default data for both the first and second fields 308, 310, just as did the initial program object 306.

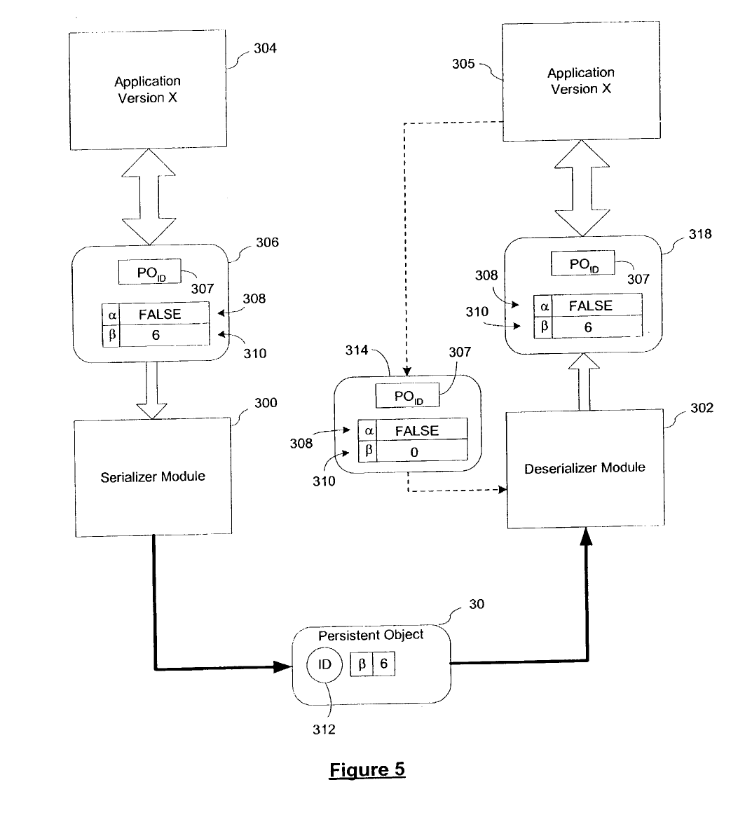

Reference is now made to FIG. 5, which shows, in diagrammatic form, the serializer module 300 and the deserializer module 302 according to the present invention, in a second example. Once again, the serializing and deserializing applications 304, 305 are both of version X.

In this example, the initial program object 306 contains a non-default value, i.e. the integer 6, in the second field 310. Accordingly, the serializer module 300 writes the second field 310 field name _ and the second field 310 data value to the persistent object 30.

The deserializer module 302 creates the blank program object 314, as before, based upon the program object ID 312. It then reads the field name _ in the persistent object 30 and attempts to find a matching field name in the blank program object 314. Once it determines that the blank program object 314 has a matching field name _, the deserializer module 302 sets the corresponding data field location in the blank program object 314 using the data value stored in the persistent object 30.

As a result, the deserializer module 302 creates the reconstituted program object 318 having a default value in the first field 308 and the non-default value in the second field 310. The reconstituted program object 318 matches the initial program object 306.

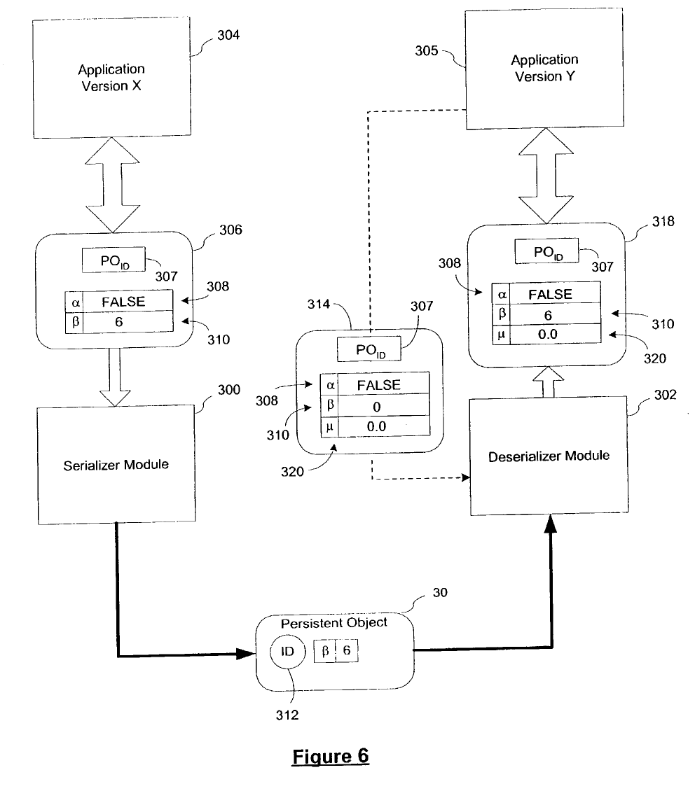

Reference is next made to FIG. 6, which shows, in diagrammatic form, the serializer module 300 and the deserializer module 302 according to the present invention, in a third example. In this example, the serializing application 304 is of version X and the deserializing application 305 is of version Y. The version Y may be an earlier version than the version X or it may be a later version.

A distinction between the version Y and the version X is that the version Y class definition corresponding to the initial program object 306 includes a third field 320, whereas the version X class definition only includes the first and second fields 308, 310. Despite this change in the content of the class definition, the name of the class in both version X and version Y is the same.

As in the second example, the initial program object 306 contains a non-default value in the second field 310, which becomes serialized in the persistent object 30 by the serializer module 300.

When the deserializer module 302 retrieves the persistent object 30 and reads the program object ID 312 stored therein, it attempts to recognize the identity of the initial program object 306 in the list of classes known to the deserializing application 305, i.e. version Y. The deserializing application 305 recognizes a class of the same name, even though the class has a slightly different definition that includes the third field 320. Accordingly, when the deserializer module 302 creates the blank program object 314 based upon the version Y class definition, the blank program object 314 includes all three fields 308, 310, and 320. These three fields 308, 310, and 320 are set to their default values.

The deserializer module 302 then steps through the persistent object 30 looking for field names. When it discovers the field name _, it matches it with the field name in the blank program object 314 and sets the corresponding data location using the non-default data serialized into the persistent object 30.

The result of the deserialization is the creation of the reconstituted program object 318 having all three fields 308, 310, and 320, rendering the reconstituted program object 318 a version Y object, rather than a reconstituted version X object. Advantageously, this permits the deserializing application 305 to assume that the reconstituted program object 318 is an object of the same version, which allows the deserializing application 305 to forego maintaining multiple code streams to deal with objects of different versions.

If the version Y is an earlier version than version X, then the change in the class definition in the example represents the removal of the third data field 320 during evolution of the application. If the version Y is a later version than version X, then the change represents the addition of the third data field 320 during evolution of the application. In either case, the deserializer module 302 is able to create a version Y object for use by the version Y deserializing application 305 from a serialized version X initial program object 306. It does this by making the assumption that any data fields that are not serialized in the persistent object 30 were not serialized because they contained default data and not because they did not exist. The version of the initial program object 306 is irrelevant to the deserializer module 302.

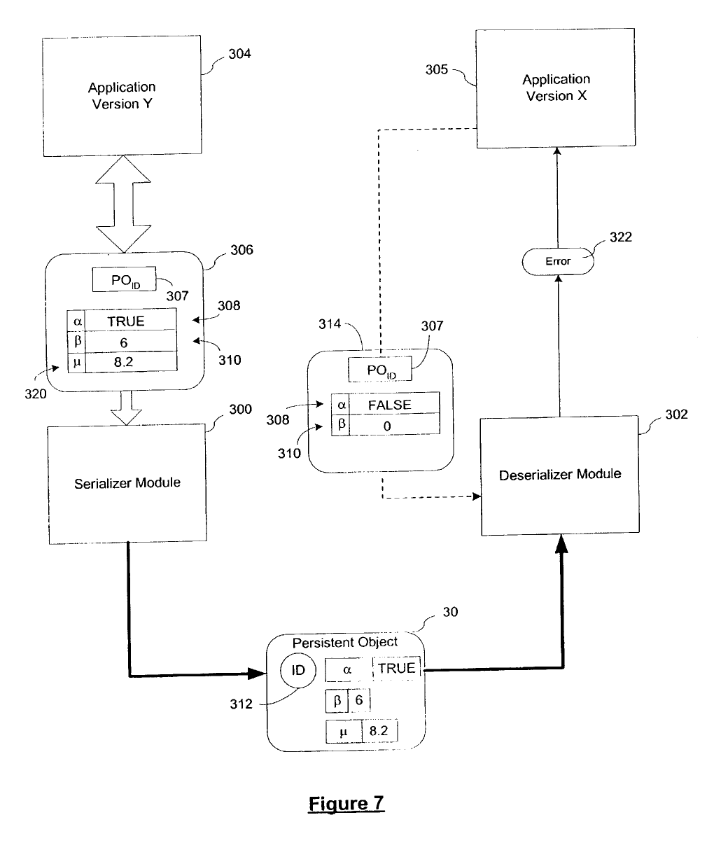

Reference is next made to FIG. 7, which shows, in diagrammatic form, the serializer module 300 and the deserializer module 302 according to the present invention, in a fourth example. In this fourth example, the serializing application 304 is of version Y, and the deserializing application 305 is of version X.

In this example, all three fields 308, 310, and 320 of the initial program object 306 contain non-default data. Accordingly, when the serializer module 300 creates the persistent object 30, it includes all three field names, _, _, and _, and the non-default data corresponding to each.

The deserializer module 302 retrieves the persistent object 30 and creates the blank program object 314 corresponding to the program object ID 312. In this case, the blank program object 314 is based upon the version X definition of the class corresponding to the program object ID 312. The version X definition only includes the first and second fields 308, 310.

The deserializer module 302 successfully allocates the data stored in the persistent object 30 corresponding to the first and second field names _ and _ to the matching field names in the blank program object 314. However, the deserializer module 302 is unable to locate a field name in the blank program object 314 corresponding to the field name _ in the persistent object 30. As a result the deserializer module 302 generates an error 322. In one embodiment, the deserializing application 305 is notified if such an error occurs and the deserializing application 305 is given the option of overriding the error and creating the reconstituted program object 318 despite the fact the data associated with the field name _ will be lost.

The above problem arises when the initial object being serialized has data fields that are not present in the object definition used by the deserializer module 302, and those initial data fields contain non-default data. If the initial program object 306 featured additional data fields because of an additional level of functionality in the serializing application 304, but those data fields were not initialized or they contained default data because the additional functionality was not being used, then the persistent object 30 would not contain data relating to those fields and the deserializer module 302 would be able to create a reconstituted program object 318. Accordingly, in many cases, the deserializer module 302 may be able to deserialize a stored persistent object 30 that was created by an application having a class definition that includes extra data fields, provided that the extra data fields only contained default information.

Although the present invention is described above in conjunction with particular computer architecture, those of ordinary skill in the art will recognize that it may be implemented upon a single computer or many computers. If more than one computer, the computers may be interconnected by way of a network or multiple networks, including the Internet, LANs, WANs, or any other network. The persistent object 30 may be stored on a local storage media or a remote storage media.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A method for reconstituting a program object from a persistent object using a computer system, said persistent object being stored on a storage media, said persistent object including a program object identification and field information, said field information including at least one field name and corresponding field data for each field name, the method comprising the steps of:
(a) parsing said persistent object to obtain said program object identification and to obtain said field names and their corresponding field data;
(b) creating a blank program object based upon said program object identification, said blank program object having a set of fields, each blank object field having a blank object field name and a blank object field data location, wherein said blank object field data locations are initialized with default values; and
(c) searching said blank program object for a matching blank object field name for each obtained field name from said persistent object, and if said matching blank object field name is found, copying said corresponding field data for said obtained field name into said blank object field location corresponding to said matching blank object field name.

2. The method claimed in claim 1, wherein said step of creating includes searching a set of known program object IDs to find one of said known program object IDs that matches the obtained program object identification.

3. The method claimed in claim 2, further including a step of generating an error if no known program object ID is located that matches the obtained program object identification.

4. The method claimed in claim 1, wherein said persistent object includes a serialization of an initial program object and said program object identification includes a class name for an initial class defining said initial program object.

5. The method claimed in claim 4, wherein said blank program object is defined by a different class having said class name, wherein said different class and said initial class are different versions of the same class.

6. The method claimed in claim 5, wherein said different class is an earlier version of said same class than said initial class.

7. The method claimed in claim 5, wherein said different class is a later version of said same class than said initial class.

8. The method claimed in claim 1, wherein said corresponding field data includes only non default values.

9. The method claimed in claim 8, wherein said default values and said non-default values are defined by a programming language.

10. The method claimed in claim 8, wherein said default values include an integer value of zero, a Boolean value of false, and a float value of zero.

11. The method claimed in claim 1, wherein said persistent object includes a file.

12. The method claimed in claim 11, wherein said file includes an XML file.

13. The method claimed in claim 1, further including a step of generating an error if said matching blank object field name is not found.

14. The method claimed in claim 1, wherein, once all of said corresponding field data is copied into said blank program object, said blank program object is said reconstituted program object, and further including a step of passing said reconstituted program object to an application.

15. The method claimed in claim 1, further including, prior to said step of parsing, a step of retrieving the persistent object from said storage media.

16. The method claimed in claim 1, wherein said persistent object is created by a serializing application and said blank program object is created by a deserializing application, wherein said serializing application and said deserializing application are different versions of the same application.

17. The method claimed in claim 16, wherein said persistent object includes the serialization of an initial program object, said initial program object is an object defined by the version of said serializing application, and said blank program object is an object defined by the version of said deserializing application.

18. The method claimed in claim 1, further including, prior to said step of parsing, a step of serializing an initial program object to create said persistent object.

19. The method claimed in claim 18, wherein said initial program object includes initial field names and corresponding initial field data, and said step of serializing includes the steps of reading said initial field names and said corresponding initial field data, and, for each initial field name, determining whether said corresponding initial field data includes non-default data, and, if said corresponding initial field data is non-default data, writing said initial field name and said corresponding initial field data to said persistent object.

20. A method of serializing an initial program object using a computer system, said initial program object including initial field names and corresponding initial field data, said initial program object further including an object identifier, wherein said method comprises the steps of:
(a) creating a persistent object;
(b) writing a program object identification to said persistent object based upon said object identifier; and
(c) determining whether said corresponding initial field data includes non-default data for each initial field name, and, if said corresponding initial field data is non-default data, writing said initial field name and said corresponding initial field data to said persistent object.

21. The method claimed in claim 20, wherein said object identifier includes a class name corresponding to a class definition from which said initial program object was created.

22. The method claimed in claim 20, wherein said persistent object includes a file.

23. The method claimed in claim 22, wherein said file includes an XML file.

24. The method claimed in claim 20, wherein said non-default values are defined by a programming language.

25. The method claimed in claim 20, further including the step of storing said persistent object on a storage media.

26. A computer program product having a computer readable medium tangibly embodying computer executable instructions for directing a data processing system to reconstitute a program object from a persistent object using a computer system, said persistent object being stored on a storage media, said persistent object including a program object identification and field information, said field information including at least one field name and corresponding field data for each field name, the computer executable instructions comprising:
(a) computer executable instructions for directing the data processing system to parse said persistent object to obtain said program object identification and to obtain said field names and their corresponding field data;
(b) computer executable instructions for directing the data processing system to create a blank program object based upon said program object identification, said blank program object having a set of fields, each blank object field having a blank object field name and a blank object field data location, wherein said blank object field data locations are initialized with default values; and
(c) computer executable instructions for directing the data processing system to search said blank program object for a matching blank object field name for each obtained field name form said persistent object, and if said matching blank object field name is found, copy said corresponding field data for said obtained field name into said blank object field location corresponding to said matching blank object field name.

27. The computer program product claimed in claim 26, wherein said computer executable instructions for directing the data processing system to create include directing the data processing system to search a set of known program object IDs to find one of said known program object IDs that matches the obtained program object identification.

28. The computer program product claimed in claim 27, further including computer executable instructions for directing the data processing system to generate an error if no known program object ID is located that matches the obtained program object identification.

29. The computer program product claimed in claim 26, wherein said persistent object includes a serialization of an initial program object and said program object identification includes a class name for an initial class defining said initial program object.

30. The computer program product claimed in claim 29, wherein said blank program object is defined by a different class having said class name, wherein said different class and said initial class are different versions of the same class.

31. The computer program product claimed in claim 30, wherein said different class is an earlier version of said same class than said initial class.

32. The computer program product claimed in claim 30, wherein said different class is a later version of said same class than said initial class.

33. The computer program product claimed in claim 26, wherein said corresponding field data includes only non-default values.

34. The computer program product claimed in claim 33, wherein said default values and said non-default values are defined by a programming language.

35. The computer program product claimed in claim 33, wherein said default values include an integer value of zero, a Boolean value of false, and a float value of zero.

36. The computer program product claimed in claim 26, wherein said persistent object includes a file.

37. The computer program product claimed in claim 36, wherein said file includes an XML file.

38. The computer program product claimed in claim 26, further including computer executable instructions for directing the data processing system to generate an error if said matching blank object field name is not found.

39. The computer program product claimed in claim 26, wherein, once all of said corresponding field data is copied into said blank program object, said blank program object is said reconstituted program object, and further including computer executable instructions directing the data processing system to pass said reconstituted program object to an application.

40. The computer program product claimed in claim 26, further including computer executable instructions for directing the data processing system to retrieve the persistent object from said storage media.

41. The computer program product claimed in claim 26, wherein said persistent object is created by a serializing application and said blank program object is created by a deserializing application, wherein said serializing application and said deserializing application are different versions of the same application.

42. The computer program product claimed in claim 41, wherein said persistent object includes the serialization of an initial program object, said initial program object is an object defined by the version of said serializing application, and said blank program object is an object defined by the version of said deserializing application.

43. The computer program product claimed in claim 26, further including computer executable instructions for directing the data processing system to serialize an initial program object to create said persistent object.

44. The computer program product claimed in claim 43, wherein said initial program object includes initial field names and corresponding initial field data, and said computer executable instructions for directing the data processing system to serialize includes instructions for directing the data processing system to read said initial field names and said corresponding initial field data, and, for each initial field name, determine whether said corresponding initial field data includes non default data, and, if said corresponding initial field data is non-default data, write said initial field name and said corresponding initial field data to said persistent object.

45. A computer program product having a computer readable medium tangibly embodying computer executable instructions for directing a data processing system to serialize an initial program object using a computer system, said initial program object including initial field names and corresponding initial field data, said initial program object further including an object identifier, wherein said computer executable instructions comprise:
(a) computer executable instructions for directing the data processing system to create a persistent object;
(b) computer executable instructions for directing the data processing system to write a program object identification to said persistent object based upon said object identifier; and
(c) computer executable instructions for directing the data processing system to determine whether said corresponding initial field data includes non-default data for each initial field name, and, if said corresponding initial field data is non-default data, write said initial field name and said corresponding initial field data to said persistent object.

46. The computer program product claimed in claim 45, wherein said object identifier includes a class name corresponding to a class definition from which said initial program object was created.

47. The computer program product claimed in claim 45, wherein said persistent object includes a file.

48. The computer program product claimed in claim 47, wherein said file includes an XML file.

49. The computer program product claimed in claim 45, wherein said non-default values are defined by a programming language.

50. The computer program product claimed in claim 45, further including computer executable instructions for directing the data processing system to store said persistent object on a storage media.

51. A data processing system for reconstituting a program object from a persistent object using a computer system, said persistent object being stored on a storage media, said persistent object including a program object identification and field information, said field information including at least one field name and corresponding field data for each field name, the data processing system comprising:
(a) means for parsing said persistent object to obtain said program object identification and to obtain said field names and their corresponding field data;
(b) means for creating a blank program object based upon said program object identification, said blank program object having a set of fields, each blank object field having a blank object field name and a blank object field data location, wherein said blank object field data locations are initialized with default values; and
(c) means for searching said blank program object for a matching blank object field name for each obtained field name from said persistent object, and if said matching blank object field name is found, copying said corresponding field data for said obtained field name into said blank object field location corresponding to said matching blank object field name.

52. The data processing system claimed in claim 51, wherein said means for creating includes means for searching a set of known program object IDs to find one of said known program object IDs that matches the obtained program object identification.

53. The data processing system claimed in claim 52, further including means for generating an error if no known program object ID is located that matches the obtained program object identification.

54. The data processing system claimed in claim 51, wherein said persistent object includes a serialization of an initial program object and said program object identification includes a class name for an initial class defining said initial program object.

55. The data processing system claimed in claim 54, wherein said blank program object is defined by a different class having said class name, wherein said different class and said initial class are different versions of the same class.

56. The method claimed in claim 55, wherein said different class is an earlier version of said same class than said initial class.

57. The data processing system claimed in claim 55, wherein said different class is a later version of said same class than said initial class.

58. The data processing system claimed in claim 51, wherein said corresponding field data includes only non-default values.

59. The data processing system claimed in claim 58, wherein said default values and said non default values are defined by a programming language.

60. The data processing system claimed in claim 58, wherein said default values include an integer value of zero, a Boolean value of false, and a float value of zero.

61. The data processing system claimed in claim 51, wherein said persistent object includes a file.

62. The data processing system claimed in claim 61, wherein said file includes an XML file.

63. The data processing system claimed in claim 51, further including means for generating an error if said matching blank object field name is not found.

64. The data processing system claimed in claim 51, wherein, once all of said corresponding field data is copied into said blank program object, said blank program object is said reconstituted program object, and further including means for passing said reconstituted program object to an application.

65. The data processing system claimed in claim 51, further including means for retrieving the persistent object from said storage media.

66. The data processing system claimed in claim 51, wherein said persistent object is created by a serializing application and said blank program object is created by a deserializing application, wherein said serializing application and said deserializing application are different versions of the same application.

67. The data processing system claimed in claim 66, wherein said persistent object includes the serialization of an initial program object, said initial program object is an object defined by the version of said serializing application, and said blank program object is an object defined by the version of said deserializing application.

68. The data processing system claimed in claim 51, further including means for serializing an initial program object to create said persistent object.

69. The data processing system claimed in claim 68, wherein said initial program object includes initial field names and corresponding initial field data, and said means for serializing includes means for reading said initial field names and said corresponding initial field data, and, for each initial field name, determining whether said corresponding initial field data includes non-default data, and, if said corresponding initial field data is non-default data, writing said initial field name and said corresponding initial field data to said persistent object.

70. A data processing system for serializing an initial program object using a computer system, said initial program object including initial field names and corresponding initial field data, said initial program object further including an object identifier, wherein said data processing system comprises:
(a) means for creating a persistent object;
(b) means for writing a program object identification to said persistent object based upon said object identifier; and
(c) means for determining whether said corresponding initial field data includes non default data for each initial field name, and, if said corresponding initial field data is non default data, writing said initial field name and said corresponding initial field data to said persistent object.

71. The data processing system claimed in claim 70, wherein said object identifier includes a class name corresponding to a class definition from which said initial program object was created.

72. The data processing system claimed in claim 70, wherein said persistent object includes a file.

73. The data processing system claimed in claim 72, wherein said file includes an XML file.

74. The data processing system claimed in claim 70, wherein said non-default values are defined by a programming language.

75. The data processing system claimed in claim 70, further including means for storing said persistent object on a storage media.

76. An article including a computer readable signal bearing medium, and including means in the medium for directing a data processing system to reconstitute a program object from a persistent object using a computer system, said persistent object being stored on a storage media, said persistent object including a program object identification and field information, said field information including at least one field name and corresponding field data for each field name, said article comprising:
means in the medium for parsing said persistent object to obtain said program object identification and to obtain said field names and their corresponding field data;
means in the medium for creating a blank program object based upon said program object identification, said blank program object having a set of fields, each blank object field having a blank object field name and a blank object field data location, wherein said blank object field data locations are initialized with default values; and
means in the medium for searching said blank program object for a matching blank object field name for each obtained field name from said persistent object, and if said matching blank object field name is found, copying said corresponding field data for said obtained field name into said blank object field location corresponding to said matching blank object field name.

77. The article claimed in claim 76, wherein said means in the medium for creating includes searching a set of known program object IDs to find one of said known program object IDs that matches the obtained program object identification.

78. The article claimed in claim 77, wherein said article further comprises means in the medium for generating an error if no known program object ID is located that matches the obtained program object identification.

79. The article claimed in claim 76, wherein said persistent object includes a serialization of an initial program object and said program object identification includes a class name for an initial class defining said initial program object.

80. The article claimed in claim 79, wherein said blank program object is defined by a different class having said class name, wherein said different class and said initial class are different versions of the same class.

81. The article claimed in claim 80, wherein said different class is an earlier version of said same class than said initial class.

82. The article claimed in claim 80, wherein said different class is a later version of said same class than said initial class.

83. The article claimed in claim 76, wherein said corresponding field data includes only non default values.

84. The article claimed in claim 83, wherein said default values and said non-default values are defined by a programming language.

85. The article claimed in claim 83, wherein said default values include an integer value of zero, a Boolean value of false, and a float value of zero.

86. The article claimed in claim 76, wherein said persistent object includes a file.

87. The article claimed in claim 86, wherein said file includes an XML file.

88. The article claimed in claim 76, further comprising means in the medium for generating an error if said matching blank object field name is not found.

89. The article claimed in claim 76, wherein, once all of said corresponding field data is copied into said blank program object, said blank program object is said reconstituted program object, and wherein said method further includes a step of passing said reconstituted program object to an application.

90. The article claimed in claim 76, wherein said article further comprises means in the medium for retrieving the persistent object from said storage media prior to said step of parsing.

91. The article claimed in claim 76, wherein said persistent object is created by a serializing application and said blank program object is created by a deserializing application, wherein said serializing application and said deserializing application are different versions of the same application.

92. The article claimed in claim 91, wherein said persistent object includes the serialization of an initial program object, said initial program object is an object defined by the version of said serializing application, and said blank program object is an object defined by the version of said deserializing application.

93. The article claimed in claim 76, wherein said article further comprises means in the medium for serializing an initial program object to create said persistent object prior to said step of parsing.

94. The article claimed in claim 93, wherein said initial program object includes initial field names and corresponding initial field data, and said means in the medium for serializing includes reading said initial field names and said corresponding initial field data, and, for each initial field name, determining whether said corresponding initial field data includes non-default data, and, if said corresponding initial field data is non-default data, writing said initial field name and said corresponding initial field data to said persistent object.

95. An article including a computer readable signal bearing medium, and including means in the medium for directing a data processing system to serialize an initial program object using a computer system, said initial program object including initial field names and corresponding initial field data, said initial program object further including an object identifier, said article comprising:
means in the medium for creating a persistent object;
means in the medium for writing a program object identification to said persistent object based upon said object identifier; and
means in the medium for determining whether said corresponding initial field data includes non-default data for each initial field name, and, if said corresponding initial field data is non-default data, writing said initial field name and said corresponding initial field data to said persistent object.

96. The article claimed in claim 95, wherein said object identifier includes a class name corresponding to a class definition from which said initial program object was created.

97. The article claimed in claim 95, wherein said persistent object includes a file.

98. The article claimed in claim 97, wherein said file includes an XML file.

99. The article claimed in claim 96, wherein said non-default values are defined by a programming language.

100. The article claimed in claim 96, wherein said article further comprises means in the medium for storing said persistent object on a storage media.
